(19) United States
(12) Patent Application Publication
(10) Pub. No.: US 2009/0132469 A1
(43) Pub. Date: May 21, 2009

(54) GEOCODING BASED ON NEIGHBORHOODS AND OTHER UNIQUELY DEFINED INFORMAL SPACES OR GEOGRAPHICAL REGIONS

(75) Inventors: IAN H. WHITE, SAN FRANCISCO, CA (US); RIYAZ FAZAL, BERKELEY, CA (US)

Correspondence Address: MARSH, FISCHMANN & BREYFOGLE LLP, 8055 East Tufts Avenue, Suite 450, Denver, CO, 80237, US

(73) Assignee: URBAN MAPPING, INC.

(21) Appl. No.: 11/941,698

(22) Filed: Nov. 16, 2007

(51) Int. Cl. G06F 17/30

(52) U.S. Cl. 707/2; 707/E17.018

(57) ABSTRACT

A computer-based method for creating a data structure for informal geographic spaces for use with geocoded databases. A set of data is stored in memory for a geographic region, and a plurality of neighborhoods is identified in the geographic region based on processing of the stored set of data. The method includes generating a boundary definition for each of the neighborhoods by processing neighborhood definition information. A data structure is created in the memory for containing neighborhood data content with at least one record for each of the neighborhoods. The data structure is populated by storing, for each neighborhood, the generated boundary definition along with a neighborhood name and identifier in the records of data structure. The boundary definition may be created by combining two or more definitions identified for a single neighborhood to provide a more inclusive geometry such as by aligning the geometries and performing an additive algorithm.

### BACKGROUND OF THE INVENTION

1. Field of the Invention

The present invention relates, in general, to geographical information systems and on-line searching of data structures with geographical indexing such as geocoded databases, and, more particularly, to computer software, hardware, computer-based methods, and related data structures used for supporting data searches, such as may be performed via an Internet search engine, that include at least one geographical search term.

2. Relevant Background

One of the most common and growing uses of the Internet is to perform local or geographic based searches. For example, a user may search for hotels near an airport or in a particular city, search for a restaurant that serves a particular type of cuisine near a particular location, or search for a library near their home. The user typically will simply access a search engine provided by any of a number of on-line service providers and enter search terms that include a geographical term such as a city or state name. Geocoding is the process of assigning geographic identifiers such as codes or geographic coordinates to map features, geographic regions or spaces, and other data records. With a database populated using geocoding, the search engine is able to use the search terms that are identified as geographical terms and return data relevant to a location or geographic region and to the other search terms (e.g., a restaurant in Los Angeles, Calif.).

Geocoding enables enterprises to apply geographic coordinates to named entities such as place names, street addresses or other entities associated with a specific physical location. Geocoding may provide an important source of revenue for e-commerce enterprises, such as Internet based search engines, advertisers, and the like. For example, e-commerce enterprises or service providers provide results to a user based on the user's entered query terms or key words or other relevant information such enterprises may provide advertising and other information or content to the user as part of the displayed search results (e.g., other restaurants or businesses that are located in the same or nearby geographic regions). For example, geocoding may involve address interpolation that makes use of data from a street geographic information system (GIS) in which a street network is mapped within a geographic coordinate space. Geocoding takes an address and matches it to a street and segments such as a particular block. Other geocoding techniques may involve locating a point at the center of a land parcel when parcel data is available in the GIS database, and in some areas, GPS is used for mapping locations.

While geocoded databases have improved on-line searching, users still often are disappointed in their results. For example, a number of such databases or spatial indexing technologies allow a user to query for objects within a particular area such as within a city or within a postal zip code or within a user-selected distance from a specified location. If the bounded area is too small, little or no data may be found that matches the search, and if the bounded area is too large, the user may be overwhelmed with search results. In other cases, the results may include numerous businesses that are not physically located in the bounded area but have simply included the geographical term or search word on their web site or in related metadata used by the search engine to find matches. As a result, the user must sift through many geographically irrelevant “matches” to find information relevant to their search.

In addition to the problem of too many hits or matches, a user may not be able to provide terms that are useful for narrowing a search or that is useful in finding all relevant data. For example, a user may enter a city name along with other search terms, but the search may not return data on entities or businesses that are located in a nearby city or a suburb of the city. In other cases, information may be missed by a searcher because a geographic region has been defined as having a particular border or boundary that is not apparent to or understood by the searcher. For example, many geocoded databases place boundaries between geographical regions along the center of a street or highway, and entities that are geocoded or indexed using such a boundary are indexed or identified with only one of the two geographic regions. In other words, geocoding involves selecting a single geographic region for a particular entity, which can cause confusion as users of a search engine may have different understandings of where boundaries, such as county and city boundaries, are physically located as they are entering their search request.

Hence, there remains a need for an improved method of populating a database or data structure with spatial indexing or geocoding. Preferably, such a method would enable providers of search engines to assist users in more accurately locating entities such as businesses by entering search terms including geographical terms readily understood by the users and/or complying with the understanding of a larger percentage of users.

### SUMMARY OF THE INVENTION

To address the above and other problems, the present invention provides methods and systems for providing a data structure that provides unique definitions of informal geographic spaces, such as neighborhoods, and provides additional content or data that is useful for geocoding a data set. It was realized that in contrast to geographic regions with well-accepted definitions such as a county or city, there are informal spaces or regions that are used to define a geography. For example, neighborhoods generally refer to a particular type of informal space and, as colloquialisms, they exist as subjective determinations with different groups of people defining their size and boundaries differently (e.g., one person may think their neighborhood extends west to a particular street while another person believes it extends further west to a different street or geographic point such as a river). When a neighborhood name is entered as a search term, the results are often surprising to the user with unwanted matches or hits and desired entities not providing a match or being missed.

Embodiments of the invention provide methods and systems for better defining informal geographic regions like neighborhoods so that users are more often satisfied with their search results and geocoding is more likely to produce more desirable spatially indexed databases. To this end, the methods of the invention recognize that neighborhoods are typically not well defined such as administrative regions like cities or counties, but, instead, neighborhoods are often more generally defined by informal boundaries that may even be the subject of community-level disagreement (e.g., there may be two or more boundary definitions for the same neighborhood). The methods described herein provide techniques for determining the available boundary definitions of a neighborhood. This may involve retrieving boundary data (i.e., geographic coordinates for a polygon or other defined neighborhood space) from a GIS or other source and/or performing research that may include subjective research such as polling of residents of a geographic region to create a database of informal spaces in the region. In some cases, the sources of boundary definitions includes data sources from the real estate industry, the hospitality/travel industry, city/municipality planning administrators, local expert knowledge sources, and other available sources.

The methods described herein may include modifying the received boundary data to be more inclusive such as by expanding the boundary outward a preset distance in one or more directions (e.g., expand out a fraction of a mile or several blocks to minimize issues with placing a boundary in the middle of a street or otherwise excluding data). This may result in neighborhoods being defined with boundaries that overlap, but this is generally accepted within the methods of the invention, with dominance of one neighborhood or other tiebreaking techniques being used if a search can only return one neighborhood result. The multiple boundary definitions (modified or not) are combined, such as by additive techniques, to create a new or revised neighborhood boundary definition that is assigned a neighborhood identifier. A data structure is created that includes geometry records for all the neighborhoods in a particular geographic region, and the records include definitions of the boundaries (e.g., polygon geometry that may be defined with geographical coordinates or the like) along with other useful content such as hierarchy data for the neighborhood, postal codes in the neighborhood, cities within the neighborhood, relationships with other neighborhoods, and more (e.g., neighborhood names in other languages and the like).

More particularly, a computer-based method is provided for creating a data structure for informal geographic spaces for use in geographic-based searching (e.g., searching of geocoded databases). The method includes operating a processor or CPU to store a set of data for a geographic region in memory or a data store. A plurality of neighborhoods is then identified in the geographic region based on the stored set of data including determining a name for each of the neighborhoods. The method includes generating a boundary definition for each of the neighborhoods by processing neighborhood definition information in the stored set of data. The processor is further operated to assign an identifier to each of the neighborhoods and to create a data structure in the memory for containing neighborhood data content with at least on e record for each of the neighborhoods.

In some cases, the neighborhood definition information includes more than one boundary geometry or definition for the same neighborhood, and the generating of the boundary definition for such neighborhoods includes combining the two boundaries to define a single, new boundary geometry. For example, the new boundary geometry may be a polygon (e.g., defined by geographic coordinates such as three or more latitude and longitude pairs) that is selected to include at least all of the area enclosed or included in the combined boundary definitions. In many cases, there is overlap between the combined definitions and also non-common area(s) or areas unique to one of the combined definitions. The generating of the boundary step may in some embodiments include modifying the boundary geometry to define a new boundary geometry (e.g., by increasing the size of the original boundary to include more area such as by moving all boundary edges outward a preset distance, enlarging the area a particular percentage or preset area amount, or by moving one or more of the defining geographic coordinates to include more area).

During the generating of the boundaries step, the computer is allowed to create boundaries that cross such that there is a common or overlapping area between two or more of the neighborhoods, and the method in these cases will include assigning weights to the neighborhoods or providing a dominance relationship between these overlapping neighborhoods to facilitate determining a “winning” or “matching” neighborhood for locations or positions within the overlapping area (e.g., when only one neighborhood can be considered to contain a geographic location, it is the dominant or more heavily weighted neighborhood). The method may further include generating a geocoded database by associating each of the neighborhoods with a set of digital content. In using the geocoded database, the method may include responding to a search request or user's query that includes a geographic term and a content term by associating the geographic term with one of the neighborhoods and returning a portion of the digital content associated with that neighborhood back as a search result. For example, the geographic term may include a neighborhood name that can be matched to one of the neighborhood names in the data structure or may include a geographic location corresponding to the boundary definition of one of the neighborhoods.

### BRIEF DESCRIPTION OF THE DRAWINGS

FIG. 1 illustrates one embodiment of a search engine system (or geographic information system (GIS) or GIS-based system) according to one embodiment of the invention that utilizes neighborhood content or a hood data structure described herein to respond to client or user search requests;

FIG. 2 is an exemplary user interface showing a web page as may be served by a search engine provider (or service provider that served data via a search engine) via a client device running a web browser or similar application;

FIG. 3 is a functional block diagram of a computer system for creating a neighborhood data structure of an embodiment of the invention that also shows use of the neighborhood data to create a geo-coded database for use by a search engine service provider;

FIG. 4 illustrates exemplary data content that may be created and stored in a data structure of the invention for each informal geographic space such as a neighborhood or similar construct;

FIG. 5 illustrates a schema diagram used in one embodiment to define content for a hierarchical data structure (such as XML) of informal regions such as neighborhoods or “hoods”;

FIG. 6 illustrates a map of a representative metropolitan area in which two definitions, which may be existing or created according to the methods described herein such as to extend outward a selected distance to include both sides of a street and/or more space, are provided for a single neighborhood;

FIG. 7 is a flow diagram for one embodiment of a method for creating and populating a neighborhood-based data structure for use in geocoding or other spatial indexing processes;

FIG. 8 illustrates a boundary definition process of one embodiment of the invention showing use of an additive approach to processing two or more boundary definitions for a single informal space or neighborhood;

FIG. 9 illustrates pairs of polygons (e.g., neighborhood boundaries) that may be presented by GIS and other data, and the polygonal boundaries may represent two definitions for a single neighborhood or two separate neighborhoods; and

FIG. 10 illustrates a weighting table that may be used to define dominance characteristics for neighborhoods in a geographic region with overlapping portions.

### DETAILED DESCRIPTION OF THE PREFERRED EMBODIMENTS

The present invention is directed to methods and systems for creating a data structure that includes unique definitions of geographic regions such as informal spaces and particularly including neighborhoods. The data structure is created by establishing a more inclusive (e.g., generally larger) definition of each neighborhood in a particular geographic region. Interestingly, the method specifically allows the definitions to overlap (and such overlap may be intentionally created as part of the boundary definition process) to provide a neighborhood mapping or organization that better correlates with users' concepts and beliefs about neighborhoods. For example, two boundary definitions may be identified for a single neighborhood, and a new boundary definition may be generated by an additive process of the two definitions. With the new boundary definition, additional data may be gathered and stored in the data structure such as the neighborhoods relationships to other geographic regions (e.g., county, city, state, country, and the like) and to other nearby neighborhoods. All or portions of this content may be provided to a search engine provider, and embodiments of the invention include creating a geocoded database using the neighborhood identifiers, neighborhood boundary definitions, and/or other content in the neighborhood data structure. A search engine is served over the Internet or other communications networks to users operating client devices, and the users may enter or be prompted to enter/select neighborhood names or terms/keywords that can be related to neighborhoods of the data structure. Search requests are processed by the search engine using the neighborhood boundary definitions and other content, and the results may include a mapping of the results with or without a showing of the used neighborhood boundaries in a user interface (e.g., an inset of a web browser display of a web page or the like).

Systems and methods are described below for managing geographically-referenced data to assist users of the Internet or other digital communications network to access data that is geocoded or linked to geographic regions such as informal regions including neighborhoods. The systems and methods, collectively referred to herein as geographic information systems (GIS), search engine systems, or geo-coding systems utilizing unique definitions of informal geographic regions or spaces (such as neighborhoods or “hoods”), may generally be configured to receive a search request that includes a search area defined by a neighborhood name (or a search term that includes a reference to a hood or geographic data that is identified as being located within one of the neighborhoods defined with boundaries described herein). A response to the search request may be a map including the neighborhood (or neighborhoods if the search identifies overlapping or adjacent hoods) along with other data/content based on the non-geographical search terms (such as a search terms related to names and locations of business or other entities in a neighborhood). In some embodiments, the returned content includes advertising such as advertising linked to the returned neighborhood. Note, the description of the invention stresses the use of the invention to create a data structure for neighborhoods, but other informal spaces may also be characterized using the boundary definition techniques as described herein. Further, some of the boundary and other concepts described herein may be applied to regions that are usually more formally defined such as cities or the like.

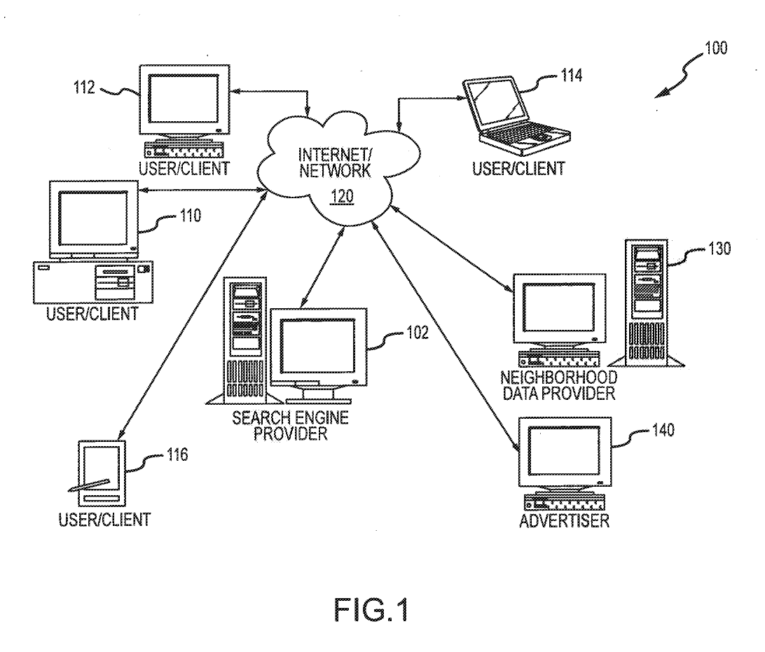

FIG. 1 is a diagram of a search engine system 100, in accordance with an embodiment of the invention. The system 100 in general enables users or clients via their client devices to search geo-coded databases by entering search terms that include a neighborhood or other informal space identifier (or other information that indicates a link or reference to a particular neighborhood). The system 100 in one embodiment includes a search engine provider 102 which may be a service provider that includes a server and other computer system devices that are linked or coupled to the network 120, and the provider 102 may be a computer network operated by a e-commerce service provider that assists users or clients in search large databases or stores of data in part based on geographical information. The system 100 further includes client devices 110, 112, 114, 116 that may be nearly any computer or electronic device that is coupled to the search engine provider 102 via a wired or wireless network(s) 120, such as the Internet, a wide area network, a local area network, and/or an intranet. The provider 102 may function by use of a website and may include one or more servers. In some cases, advertiser(s) 132 may also be coupled to the map manager 102 via a network 122 to provide advertising content that they request be linked to particular neighborhoods (e.g., be displayed when a user requests any or particular information that is spatially indexed to a neighborhood). Significantly, the system 100 further includes a neighborhood data provider 130 that transfers informal space or neighborhood content or data to the search engine provider 102 for use in responding to search requests. The particular data structures and/or content created by the neighborhood data provider 130 are significant features of the invention and are described in detail below.

In general, the users of the system 100 connect with the search engine provider 102, which serves up web pages and may implement features of the present invention. For example, the search engine provider 102 responds to requests for data by client devices 110, 112, 114, 116. The data received by client devices from the search engine provider 102 are accordingly processed and presented in a user interface provided in each device 110, 112, 114, 116. The client computer systems or devices may be users of the network 120. These client devices 110, 112, 114, 116 may be network-enabled devices including, but not limited to, Web-enabled wireless phones, personal digital assistants (PDAs), smart phones, Internet-enabled video game devices, and interactive televisions. These client devices enable users to interface with the search engine provider 102 using various I/O mechanisms, including, but not limited to, keyboard entries, voice-activated commands, touch-tone phone interfaces, and touch screens.

The functions and features of the invention are described as being performed, in some cases, by mechanism, devices, and modules that may be implemented as software running on a computing device and/or as firmware and/or hardware. For example, the neighborhood (or other informal geographic space or region) data provider 130 may operate to process GIS or other information such to define neighborhood boundaries and create neighborhood-based data content using processes or functions described herein, and these processes or functions may be performed by one or more processors or CPUs running software modules or programs. The methods or processes performed by each module is described in detail below typically with reference to flow charts or data/system flow diagrams that highlight the steps that may be performed by subroutines or algorithms when a computer or computing device runs code or programs to implement the functionality of embodiments of the invention. Further, to practice the invention, the computer, network, and data storage devices and systems may be any devices useful for providing the described functions, including well-known data processing and storage and communication devices and systems such as computer devices or nodes typically used in computer systems or networks with processing, memory, and input/output components, and server devices configured to generate and transmit digital data over a communications network. Data typically is communicated in a wired or wireless manner over digital communications networks such as the Internet, intranets, or the like (which may be represented in some figures simply as connecting lines and/or arrows representing data flow over such networks or more directly between two or more devices or modules) such as in digital format following standard communication and transfer protocols such as TCP/IP protocols.

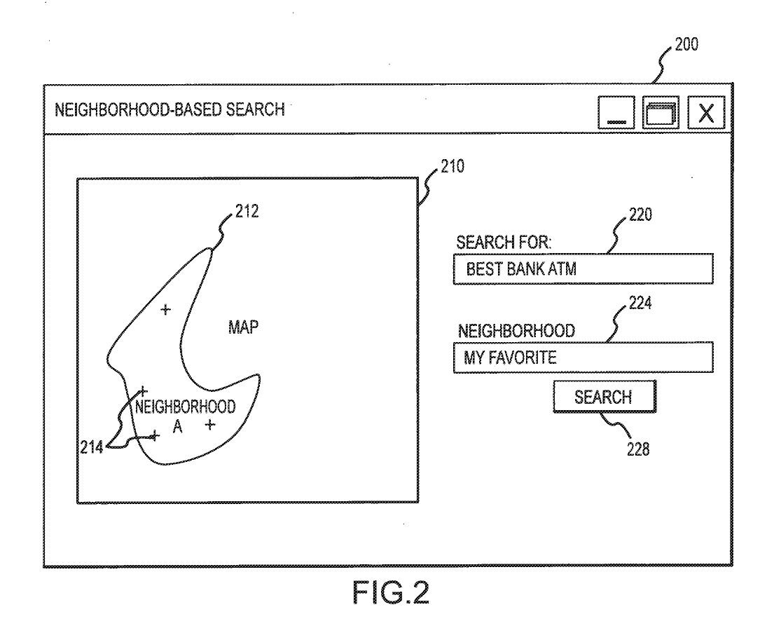

FIG. 2 is an example user interface 200, illustrating for example, a window or a web page on a web browser of one of the client devices 110-116 (e.g., a GUI provided by use of a conventional web browser or similar application including MICROSOFT™ Internet Explorer and Firefox™ from Mozilla or the like). The various features of the user interface are performed by the search engine provider 102 by itself or by communicating the neighborhood data provider 130. In one embodiment, the resulting web page 200 displays various sets of information, such as a map 210, search result listings (e.g., a text listing with or without hyperlinks to other web pages) associated with the map 210, an inset area for showing more information about a particular entity or search result listing, and a featured business or other advertising associated to the neighborhood used in the search (or specified by the user).

The user interface 200 includes devices common to web pages for allowing a user to enter search terms or words such as drop-down list, boxes, or other elements facilitating user input and selection. As shown, boxes 220, 224 are provided for a user to enter search terms and a button 228 is provided to initiate the search. In other cases, a user may request a map 210 and select one or more areas (such as neighborhoods or other informal spaces 212) to perform the search. In the user interface 200, the user is prompted to enter non-geographical search terms in box 220 such as words related to a particular entity and to enter geographical terms in box 224 that specify a neighborhood or other informal space to search with the terms in box 220. The terms entered in box 224 are processed to identify a spatial index or a geo-code identifier (such as a name of a neighborhood or an alias), and the search uses this geo-code identifier to provide data matching the terms or words in box 220. The results may be displayed as map 210 with a boundary of the neighborhood 212 optionally shown along with locations of matching entities 214 (e.g., locations of ATMs in the neighborhood). In other embodiments, a single text box is provided to the user in the user interface 200 and the entered terms are processed to identify neighborhood names or to identify geographic data that is then linked to a particular neighborhood (e.g., by searching data provided by neighborhood data provider 130 to determine which one or more neighborhoods correspond to particular geographical coordinates such as a street address, a street cross section, a postal zip code, latitude and longitude data, and the like). The particular arrangement of the neighborhood-based search interface 200 is not limiting to the invention but is provided to clarify that data structures and methods described herein are particularly useful for allowing users to effectively search using more informal geographic information such as the name of a neighborhood or another informal region.

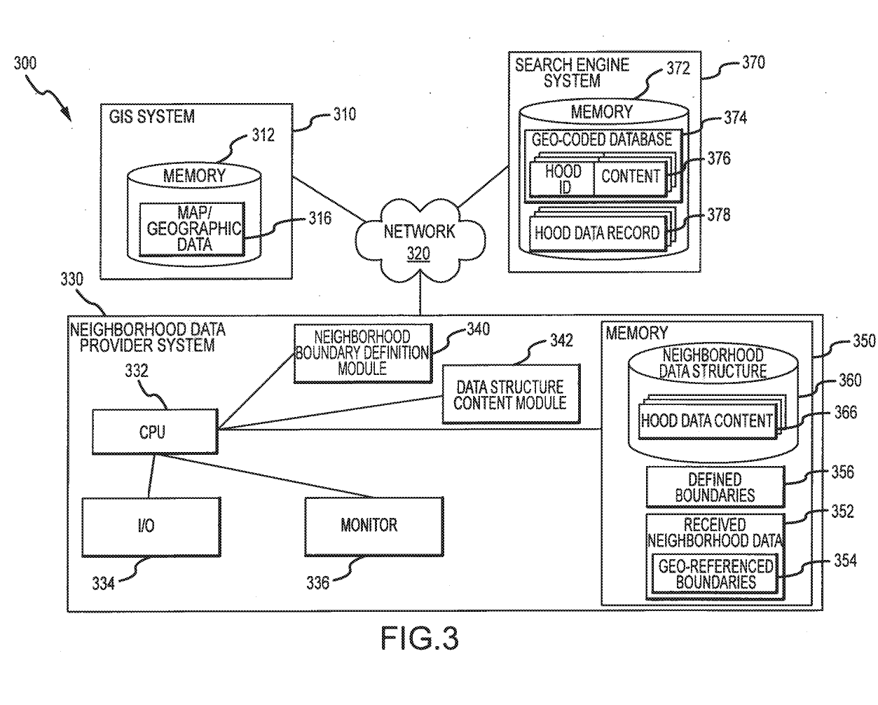

FIG. 3 illustrates a functional block diagram of a computer system 300 of an embodiment of the invention that is configured for generating and populating a neighborhood data structure 360. The contents of this structure 360 are used to create a geocoded database 374 for use by a search engine system 370 in response to geographic-based queries or search requests. The system 300 includes a GIS system 310 such as a server or computer network/system with memory 312 that stores map/geographic data 316. The GIS system 310 is connected to network 320 such as the Interne to provide a communications link with a neighborhood data provider system 330. The GIS system 310 is intended to represent one source of information on neighborhood or other informal regions or spaces including map or geographic data 316 that may provide boundary definitions such as polygon geometry in geographic coordinates or the like (e.g., latitude and longitude of three or more points that are used to define a polygon). Of course, other GIS systems may be included and other sources of data used to populate the neighborhood data structure 360 such as real estate databases, municipality planning databases, governmental databases, and the like.

The neighborhood data provider system 330 may take a number of forms to practice the invention and is shown as including a CPU 332, an I/O 334 (such as keyboard, GUI, touchscreen, voice command modules, touchpads, mouse, and the like), and monitor 336. These components of a typical computer system or workstation are used by an operator to enter data and initiate software/firmware (e.g., to work with the computer system 330 to generate and populate the data structure 360 and/or to transfer content 366 to search engine system 370). The system 330 includes a neighborhood boundary definition module 340 along with a data structure content module 342 that are implemented or run by processor 332 to allow an operator request, select, and modify neighborhood data such as boundaries and to manipulate this data and/or to enter additional data to create neighborhood data content 366. For example, the modules 340, 342 may present a user interface on monitor 336 that is used to initiate communications with GIS system 310 and to view and process any received data from this and other data sources for neighborhoods.

As shown, the system 330 includes memory 350 (which may also be provided in a separate device or system accessible by CPU 332). Data received from the GIS system 310 and other systems/sources (not shown) is stored as received neighborhood data 352. For example, the boundary definition module 340 may request neighborhood definitions from GIS system 310, and this may include one or more polygon geometries that are stored as boundaries 354. The module 340 may further be used to view the existing boundaries of a neighborhood via a displayed map on monitor 336 (or a GUI on monitor 336) and/or display defining geographic coordinates. The operator may be prompted to save these boundaries as defined or final boundaries or to adjust the boundaries. For example, two, three, or more boundary definitions may be received for a single neighborhood, and the module 340 can initiated by the operator to combine the boundaries to form a single boundary definition (e.g., an additive procedure as explained below or other combination subroutine useful for creating a single boundary based on multiple definitions). In other cases, one or more of these boundaries may be modified manually (e.g., to correct for known errors, to input received polling or other data indicating that additional or less area should be included, or the like) or automatically (e.g., by applying a routine to expand (or shrink) the area a particular amount or percentage such as to include an additional fraction of a mile such as 0.1 to 0.75 miles or to be increased on all or select sides by a percentage such as increasing by 1 to 10 percent or the like). Then, these modified boundaries can be combined to form a single defined boundary for each neighborhood (and/or the combined boundaries can be modified as discussed rather than performing the modification before combining).

The data structure content module 342 is then utilized by the CPU 332 to further process the neighborhood data 352 along with other data entered by an operator (or transferred in from other sources (not shown)) to create the neighborhood data structure 360 and populate it with content 366. At a minimum, records or files are created that include a field that identifies each neighborhood (e.g., a HOODID or the like) and provides additional descriptive content including the boundary definition (or polygon geometry in some embodiments in geographic coordinate form). Typically, additional data is provided including how a searching entity can handle searches that produce two overlapping neighborhoods (which is allowed according to embodiments of the invention) and other information regarding relationships with other neighborhoods and hierarchical geographic relationships.

The hierarchical relationships or hierarchy of a neighborhood may be provided in the hood data content 366 and computed algorithmically by the data structure content module 342 (or another routine not shown or by module 340). For example, when a neighborhood has a boundary definition such as a polygon that is contained with a larger neighborhood or other geographic area polygon (e.g., a county or city or the like) there is said to be a parent-child (or similar hierarchical) relationship between the two geographic areas. In one practical example, SoHo and Downtown may be considered two neighborhoods in New York City, N.Y., and a point located in SoHo is by definition also in Downtown. Hence, there is a parent-child relationship determined for the Downtown and SoHo neighborhoods.

Having this relationship indicated in the hood data content 366 may be useful for helping an application developer (e.g., a search engine service provider or the like) build logic into their application to facilitate searching of geocoded data. An example, may be to use this parent-child relationship for a neighborhood(s) is to associate hierarchy with a given zoom level on a map. This becomes useful when a searcher is viewing a metropolitan area such as New York City on a map and clicks on a location or point within the child, such as SoHo, they are returned a map that includes the parent, such as Downtown. If the searcher zooms in or drills down, such as to Manhattan, they still would be returned parent information due to the hierarchy relationship. In this manner, application developers can provide more contextually-relevant data. In one preferred embodiment, an online map application, such as Google Maps, may associate hierarchy as provided herein with a given set of map tiles such that parent neighborhoods are rendered onto one set of tiles and child relationships are rendered onto another (e.g., more detailed) set of tiles. The use of map tile rendering and caching is becoming more common as it allows map tiles to be pre-computed or determined, rendered, and cached so as to allow prompt response to map-based searched as a user drags and clicks during their accessing of map-based and/or geocoded data.

The system 300 further includes a search engine system 370 coupled to the network 320 such that the system 370 and neighborhood data provider system 330 can communicate and transfer data back and forth over network 320. Search engine system 370 generally functions to serve a search engine to client devices linked to the network 320 (as discussed with reference to FIG. 1) via a browser or the like. The clients enter search requests with search terms including geographic terms that are linked by the search engine system 370 to neighborhood identifiers or IDs. In this regard, the provider system 330 typically transfers all or portions of the neighborhood data content 366 (or the data structure 360) over the network 320 to the search engine provider 370 (or the information may be stored in media such as disks, portable hard drives, or the like and transferred physically to the location of the system 370 for loading/use). The data structure 360 or data stores may be databases, such as relational database management systems, object-oriented database management systems, linked lists, arrays, flat files, comma-delimited files, and the like.

The system 370 includes memory 372 in which the received data/content from the provider system 330 is stored as shown with hood data records 378. The system 370 is shown to have created a geocoded database that is indexed (at least in part) with the hood IDs in records 376 that also includes other content. For example, each of the records 376 may include an ID of a neighborhood plus content relevant to that neighborhood such as businesses and other entities that are physically located within the newly-defined boundaries of the neighborhood or that have requested to be associated with the neighborhood (e.g., an advertiser may want their advertisements shown in results for a nearby or other neighborhood). The hood data records 378 may be used for neighborhood search requests such as to locate a neighborhood by its boundaries and also to determine how to handle multiple matches for a single search (e.g., more than one neighborhood matches a user's search and only one “match” can be returned in the result).

In practice, it will be understood that the use of neighborhoods has significance in the United States in areas of relatively high urban population density. Other informal spaces may be used in other countries and in areas of lower population. For example, as population per unit area of land falls neighborhood names become less meaningful, and population concentrations may result in irregular shapes and may include neighborhoods that include “islands” in which two or more areas that are spaced apart are within a single neighborhood, that omit space creating “doughnuts” or similar shapes. Also, some areas may simply not be included in any neighborhood or informal space, and such conditions are typically allowed in embodiments of the invention (i.e., the neighborhood methodology does not force all land in a geographic region to be placed within at least one neighborhood as this likely would result in false positives or inappropriate matches as entities in rural areas or suburbs sometimes are in no neighborhood).

The particular configuration of a neighborhood data structure and its contents can vary widely to practice the invention and can vary to suit a search engine or other user's needs. Also, it is likely that the content will vary from country to country. In the United States, an embodiment the content will include an identifier, code, or ID for each neighborhood along with its spatial data (e.g., geographic coordinates defining a polygon or other shape used to define a geographic region). Typically, these portions of the content are not considered attributes but in some cases spatial joins may be provided across a variety of geodata. In one embodiment, an attribute table includes that following attribute fields or content: (a) native name that provides a native language name for the neighborhood; (b) postal field to provide postal codes intersecting or found in the neighborhood; (c) city defining a primary municipality (e.g., 51 percent or more of the neighborhood is in this city); (d) province/state to define a primary state or provincial administrative region for the neighborhood; country to define the primary country; (e) a hierarchy field to provide hierarchical data for the neighborhood (e.g., if a neighborhood is nested fully within another neighborhood's boundaries, the larger is typically designated as the parent and multiple nests may exist such as when city, county, state, country, and the like is provided; may appear in code as “childof”); (f) alias attribute or extension to define secondary names for neighborhoods (e.g., a single neighborhood may be called multiple names, and in one case, multiple neighborhoods are provided with the same boundary or polygon geometry with a relationship provided among the like polygons; code may be “aliasof” or the like); (g) dominance to define which neighborhood “wins” in certain overlap conditions (e.g., in some cases, a point query can only return a single neighborhood, and dominance assigned to the neighborhoods in overlap can be used to resolve the issue; coded as “dominates”); and (h) foreign language to provide localized versions by region or by prominent language usage (e.g., the names of neighborhoods may be provided in English, French, Italian, German, Spanish, Chinese, and many more languages).

Regarding the alias or synonym attribute, data collection for neighborhood data content generally involves researchers taking into account a variety of information. This information may be included in the data content and may include historical, cultural, and geographic nuances as well as idioms and colloquialisms regarding neighborhood definitions and boundary locations as well as what local and other populations use as names or labels for an area. For example, one geographical area or polygon-defined space may be referred to in different ways such as “LoDo” for an area of downtown Denver, Colo., which is also called “Lower Downtown” by others, and this represents a synonym or alias relationship. In New York City, N.Y., “Hell's Kitchen” neighborhood has been “rebranded” as “Clinton”, but the geographic boundary (in this case) is the same polygon and locals consider it to have the same boundary locations. These multiple names are associated according to some embodiments of the invention by associating them with the geographic region or boundary definition that they represent or to which they correspond. There can be multiple synonyms or aliases for a single polygon. In one embodiment, one of these is deemed a principal name for the neighborhood, and this is associated with the neighborhood. There are also, in some cases, aliases associated with formally-designated places such as municipalities, and these may be included in the neighborhood data content or otherwise accounted for in the systems described herein (e.g., Massachusetts may be called the Bay state, Detroit, Mich. may be called Motown, and the like).

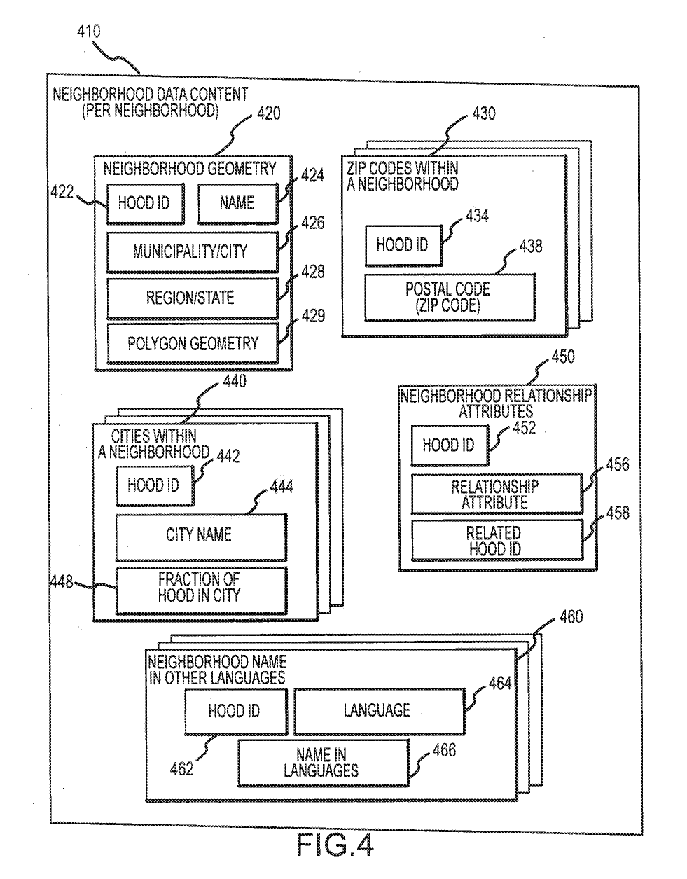

FIG. 4 illustrates neighborhood data content 410 that may be provided in a representative data structure of the invention. As shown, the content 410 may be provided for each neighborhood (or other informal space) in a geographic region or area to allow geocoding to be performed using such informal spaces (e.g., with the content 410 being provided to a search engine provider or otherwise used to build a geocoded database or data store). The content 410 includes a neighborhood geometry record 420 that includes the following fields: neighborhood identifier; name of the neighborhood; municipality or city containing the neighborhood (or primary city); region or state containing the neighborhood and city; and the polygon geometry (i.e., the boundary definition created for the neighborhood using methods described herein such as geographic coordinates defining outer edges of the neighborhood space). The content 410 also includes one or more records 430 for zip codes for the neighborhood that include the hood identifier 434 and a postal code or zip code field 438. A record 430 is typically provided for each zip code or postal code falling within the defined boundary of the neighborhood.

In some cases, a neighborhood may be located in two or more cities, and this is especially true when boundaries are combined in an additive manner with or without expanding the boundaries received as definitional input. Some neighborhoods may than straddle more than one city boundary. The content 410, in these cases, includes records 440 for neighborhoods that have this multiple city property. As shown, the records 440 include a hood ID 442, a city name 444, and a percent or fraction of the neighborhood in the particular city 448 (which may be used to provide a response to certain search requests on a neighborhood). The content 410 further includes a record 450 defining the neighborhood relationship attributes with a hood ID field 452, a relationship attribute 456, and a related hood ID field 458. This record 450 is useful because neighborhoods may overlap, nest (e.g., boundary is 100 percent contained within a larger boundary), or have the same boundary but different name (e.g., alias). When a search point returns more than one record, for example, it may be desirable that these relationships be available for use in resolving the result to one neighborhood. For example, the relationship attribute 456 may be used such as by applying the principle of dominance for overlapping neighborhoods to return the hood previously identified as important or dominant neighborhood. In some cases, the content 410 may include records 460 with fields for hood ID 462, a language 464, and the name of the neighborhood in that language 466, which may be useful for some regions (such as Europe and Canada) where neighborhood names within a single country have names in multiple languages.

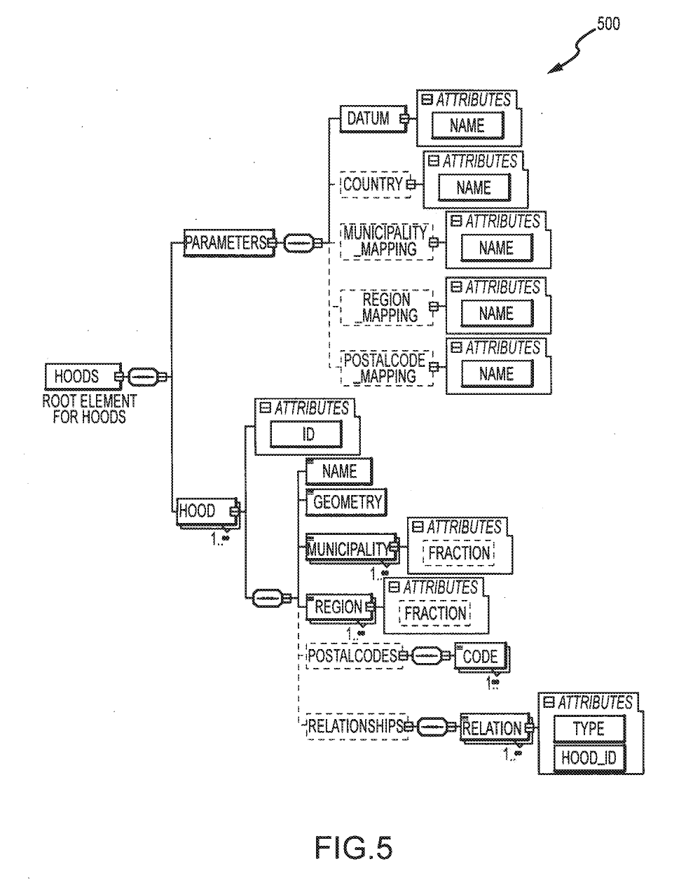

The data format for the content 410 may vary widely to practice the invention such as, but not limited to, CSV and XML formats. The geometry coordinates may be provided in the Open Geospatial Consortium Well-Known Text (WKT) format, Geographic Markup Language (GML), or other useful conventions, with the geometry in some embodiments being polygon or multipolygon, and the neighborhood geometry coordinates may be based on the longitude/latitude decimal degrees (e.g., WGS 84 datum or the like). FIG. 5 illustrates a representative XML schema 500 in diagram form that may be used in some embodiments of the invention to create data content for a neighborhood data structure.

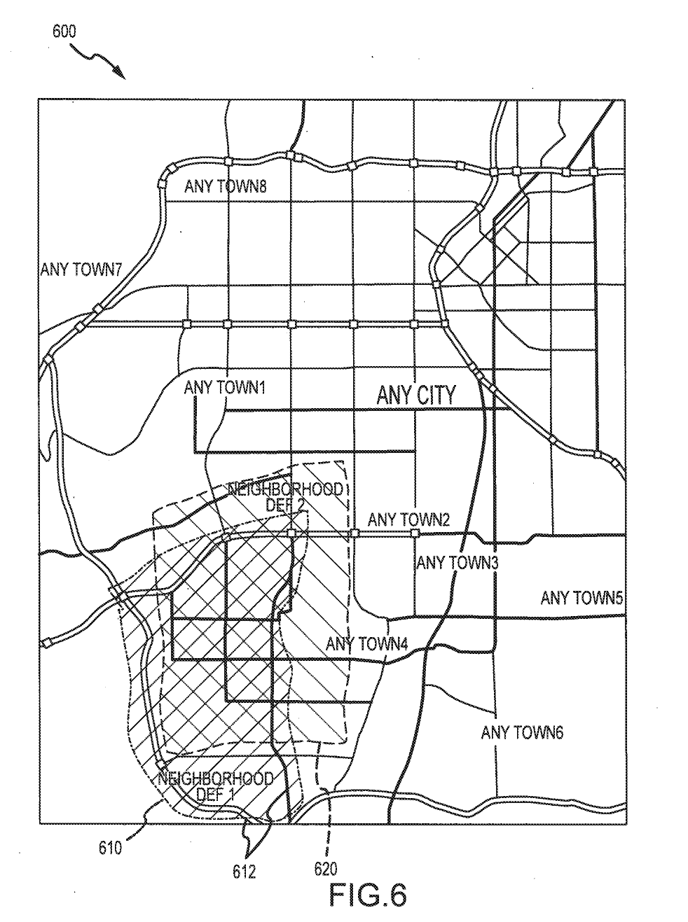

FIG. 6 illustrates a map or image 600 of one representative urban area or geographic region. As shown, a single neighborhood has a first and second definition of its boundaries 610 and 620. These boundaries 610, 620 are shown according to one embodiment of the invention to illustrate how an expansion may be applied to move the boundaries 610, 620 outward so as not to fall on the center of roads or streets, such as streets 612, or to otherwise provide a larger coverage to provide more positive matches for geographic, neighborhood-based queries (e.g., by expanding one or more side of a polygon outward a traction of a mile or more). As shown, the boundaries 610, 620 are defined differently to include differing space or areas. Instead of choosing one definition, a single boundary is preferably generated by combining the boundaries 610, 620 in an additive manner (as explained below) to include at least all the areas within both boundaries 610, 620 (e.g., before or after modification of each of the boundaries or of particular polygon boundary sides or defining points).

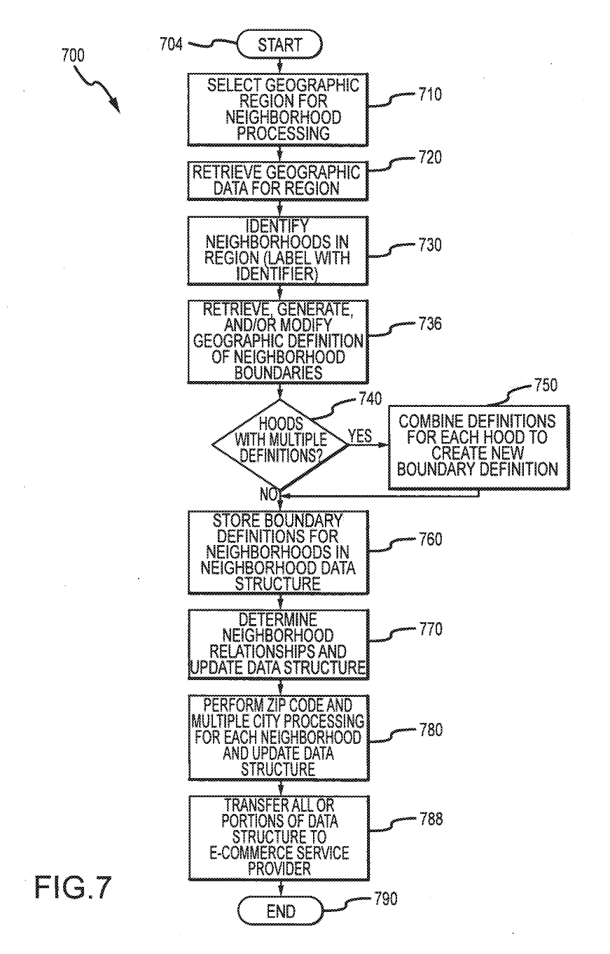

FIG. 7 illustrates an exemplary method 700 for generating and populating a neighborhood data structure. The method 700 starts at 704 such as with defining a schema for creating a set of records and/or information sets for an informal space such as a neighborhood and identifying sources for the information selected for inclusion in the data structure. At 710, a geographic region is selected for processing such as country, a state, a portion of a state, or a suburban area. For this region, the method 700 continues at 720 with retrieving geographic data for the region, which may include retrieving from a GIS or other source boundary definitions of neighborhoods. At 730, neighborhoods within the region are identified (and, in some cases, labeled with a hood identifier). In some cases, the identification of neighborhoods will include obtaining neighborhood names and geometry from a variety of sources such as real estate industry databases, polls of citizens in the region, city/municipality planning commission databases, and the like. At 736, the method 700 continues with retrieving, generating, and/or modifying geographic definitions of the neighborhood boundaries. This may include using an already established polygon geometry for a neighborhood, which can then be accepted or used as-is or with some modifications (e.g., expanding the boundary outward a preset distance or on a case-by-case basis). In some cases, a boundary definition may need to be created for a particular neighborhood (such as bases on information from one of the sources).

At 740, the method 700 continues with determining whether there are one or more neighborhoods with two or more boundary definitions. If so, at 750, the definitions are combines for each of these hoods to create a single, new boundary definition, e.g., by using an additive approach that includes all area of each of the defined neighborhood boundaries such that the new definition is larger and inclusive. At 760, the method 700 continues with storing in memory (e.g., in a neighborhood data structure) the neighborhood geometries (or boundary definitions) for each neighborhood along with its identifier or ID. In some embodiments, other collected data is also stored in the data structure (as explained with reference to FIGS. 4 and 5. The method 700 may continue at 770 with determining the neighborhood relationships for each of the neighborhoods in the data structure and updating the data structure. For example, overlapping or nested neighborhoods may be identified and relationship information may be stored in the data structure. At 780, the method 700 may include processing each neighborhood to determine zip code and city data and the data structure is updated based on this processing (e.g., to identify each zip code or postal code for a hood and/or to indicate when neighborhoods fall in more than one city). At 788, the data in the structure (or portions of it) may be transferred such as over the Internet or on storage media to an e-commerce service provider (e.g., one that serves search engines to allow users to query geo-referenced data or data indexed using the boundary definitions and/or the hood identifiers). The method 700 then ends at 790 (or is repeated for an additional geographic region).

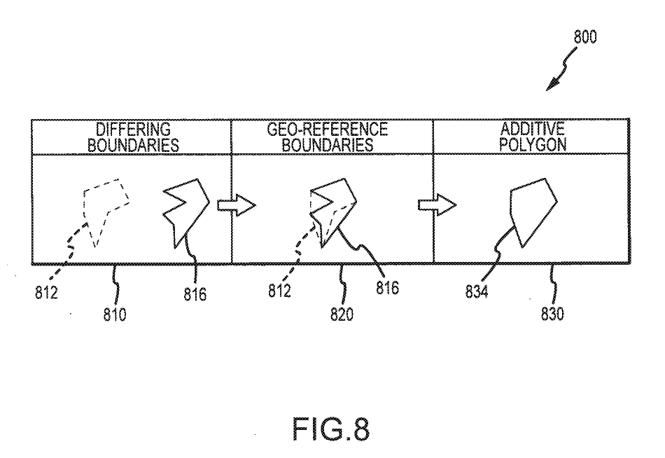

FIG. 8 is useful for illustrating one technique for defining the boundaries (or geometries or bounding polygons) of informal spaces such as neighborhoods. The illustrated method 800 is generally rooted in spatial cognition This is true in part because perception of an informal space and its boundaries may be unique to an individual or to a set of individuals. To this end, the defining geometry may reflect this imprecise belief or understanding of groups of people. The method 800 accounts for these differing perceptions of space boundaries with an additive approach such that two or more boundaries for a single area are combined to be inclusive of the geographic area defined by all the boundaries.

In the example method 800, a single neighborhood is defined by sources of information 810 as having two differing boundaries 812 and 816. The two polygons 812, 816 are indicative of two interpretations of a single neighborhood. After retrieving (and in some cases modifying as discussed above) the definitions at 810, a combining step 820 is performed to geo-spatially align the two boundaries 812, 816. Although overlap exists, there is also non-common areas or space. The result of the processing is shown at 830 with the polygon 834 in which points from both polygons 812, 816 are incorporated or included in the newly-generated boundary 834 for the neighborhood. In use, the neighborhood boundary 834 may be useful for responding to queries input to a geocoded database in a broader sense. This is desirable because if only one of the boundaries 812, 816 were used instead of polygon 834 the search results would not find as many matches as a user may expect for the neighborhood (e.g., the polygon 834 better identifies a search area for a larger percentage (or nearly all) of possible users of a search database).

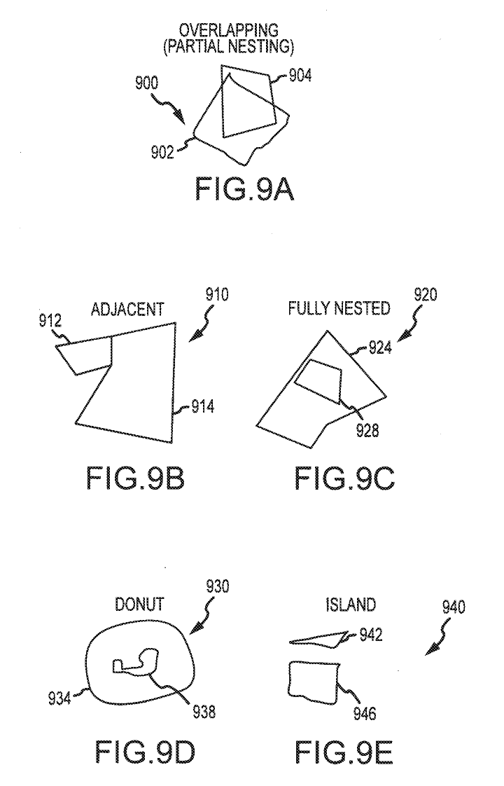

FIGS. 9A-9E illustrate representative polygons or neighborhood boundary shapes that may be formed according to the additive method of the present invention (again, with or without modifications of input boundary definitions to be more inclusive prior to combining). FIG. 9A illustrates input definitions 902 and 904 that are partially overlapping, and when combined at 900 form a larger hood definition that includes non-common area contributed by both polygons 902, 904. FIG. 9B illustrates input or original space definitions 912, 914 that may be combined at 910 to form a new neighborhood boundary definition that is inclusive of areas of the adjacent but non-nesting perceptions of the space. FIG. 9C illustrates two input neighborhood geometries 924, 928 that when combined at 920 into a single definition take on the shape if the larger polygon 924. FIG. 9D shows a donut shape in which a combination at 930 of inputs results in an outer polygon definition 934 and an inner, excluded definition 938, and the shape is donut-like with the area enclosed within polygon 938 being excluded from the neighborhood formed at 930. FIG. 9E provides another situation in which the input polygon or boundary definitions 942, 946 are not overlapping or adjacent but, instead, are spaced apart. However, after the combination at 940, the two polygons 942, 946 are combined to provide a definition of a boundary of a single neighborhood (e.g., a definition that is inclusive of all areas enclosed by the input or source neighborhood boundary definitions 942, 946).

In other cases, the shapes or boundaries shown in FIGS. 9A-9E may be separate neighborhood boundaries that may need to be processed to respond to a search engine query. For example, dominance may apply to FIGS. 9A and 9C to determine the “winner” when a point or geographic location is placed in the overlapping portion or area, e.g., when only one neighborhood can be returned as a match a dominance definition may be provided as part of the hood content such that the search engine will return the one that dominates over the other. Hierarchy information may also be provided in eh case of FIG. 9C such as by indicating that neighborhood 928 is a child of neighborhood 924 (and/or neighborhood 924 is a parent of neighborhood 928).

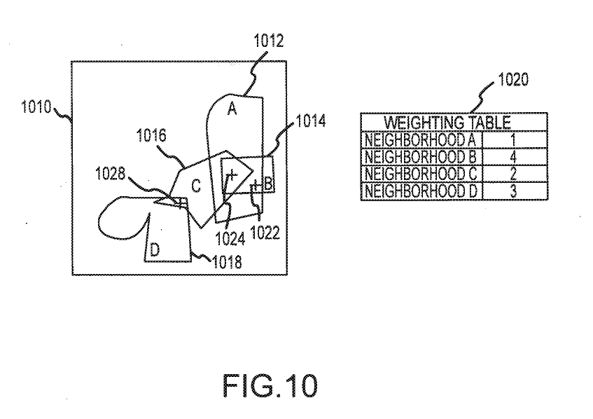

FIG. 10 is provided to further explain how to handle issues with overlapping neighborhoods, which is a situation unique to the described bounding method of the invention because this method allows geographic areas to be in more than one neighborhood. FIG. 10 illustrates a map 1010 in which four neighborhoods are defined by boundaries or polygons 1012, 1014, 1016, and 1018. As shown, there is overlapping occurring in the map 1010 as some neighborhoods cover similar areas of the mapped region. Some searching algorithms or requests may only be properly satisfied by returning a single neighborhood. One technique for addressing this issue is to assign a dominance (or weight) to each neighborhood to determine which “wins” or is selected when a point is located in two or more hoods. One representative weighting or dominance table 1020 is shown in FIG. 10. If a search request provided a geographic location (or entity that is located at a point) of 1022 and only one neighborhood can be returned, a determination has to be made between neighborhood “A” and neighborhood “B”. From the table 1020, it is seen that neighborhood “B” has a greater weight or is dominant over neighborhood “A” and is returned for point 1022. Point 1024 is located in an overlap region of three neighborhoods, and again neighborhood B is returned as having the greatest weight or being dominant. Point 1028 is located in the overlapping region between neighborhoods “C” and “D”, and since neighborhood “D” is dominant over neighborhood “C” it is returned in response to a query including point 1028.

Those skilled in the art will recognize that other tiebreaking techniques may be used to handle the issue of overlapping neighborhoods, and it is believed that the benefits associated with more inclusive (or larger) boundary definitions for neighborhoods are significantly greater than any minor issues with resolving multiple neighborhood matches to queries. For example, an overlapping of neighborhood boundaries may be determined by a data structure content module 342 (or other routine or code device) such as by identifying overlapping areas of less than the value used to identify a parent-child relationship (e.g., less than about 97 percent overlap, less than 90 percent overlap, or the like). A minimum overlap may also be set to allow some overlap near boundaries such as at least 1 to 5 percent overlap with greater than about 3 percent overlap in one embodiment. Determining which neighborhood (or polygon) is dominant may be determined using weighting as described above with the weights assigned by a number of factors such as population density of a neighborhood, area/shape of the polygon or boundary definition, proximity to other neighborhoods, other demographics, and the like. These factors may also be used in dominance routines that differ from the weighting technique described above.

As mentioned above, it is common for informal spaces such as neighborhoods to have more than one name. This may reflect cultural, historical, or other beliefs. For example, Hell's Kitchen is a neighborhood in New York City, N.Y. that has been re-named or branded as Clinton by the real estate industry and others. In this case, a single boundary is defined for both of these neighborhoods such that both share the same polygonal boundary but differ only in name. From a user it is valuable to have these multiple names as it increases the likelihood of all users entering a query to a search engine. Aliases may be used in the data content and this relationship may be included in the records in embodiments that create separate records/data content for each name. If only one name or neighborhood can be returned for a point, one of these names is chosen or identified as a principal and is returned in these cases.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. In this description, numerous specific details were introduced to provide a thorough understanding of, and enabling description for, embodiments of the neighborhood geo-coding systems and other systems and methods of the invention. One skilled in the relevant art, however, will recognize that these embodiments can be practiced without one or more of the specific details, or with other components, systems, and the like. In other instances, well-known structures or operations are not shown, or are not described in detail, to avoid obscuring aspects of the disclosed embodiments. Unless otherwise indicated, the functions described herein are performed by programs or sets of program codes including software, firmware, executable code or instructions running on or otherwise being executed by one or more general-purpose computers or processor-based systems. The computers or other processor-based systems may include one or more central processing units for executing program code, volatile memory, such as RAM for temporarily storing data and data structures during program execution, non-volatile memory, such as a hard disc drive or optical drive, for storing programs and data, including databases and other data stores, and a network interface for accessing an intranet and/or the Internet. However, the present invention may also be implemented using special purpose computers, wireless computers, state machines, and/or hardwired electronic circuits.

The term “Web site” is used to refer to a user-accessible network site that implements the basic World Wide Web standards for the coding and transmission of documents. These network sites may also be accessible by program modules executed in computing devices, such as computers, interactive television, interactive game devices, wireless web-enabled devices, and the like. The standards typically include a language such as the Hypertext Markup Language (HTML) and a transfer protocol such as the Hypertext Transfer Protocol (HTTP). Other protocols may also be used such as file transfer protocol (FTP), wireless application protocol (WAP) and other languages such as the extensible markup language (XML) and wireless markup language (WML). It should be understood that the term “site” is not intended to imply a single geographic location, as a Web or other network site can, for example, include multiple geographically-distributed computer systems that are appropriately linked and/or clustered together. Furthermore, while the following description explains by example an embodiment utilizing the Internet and related protocols, other networks, whether wired or wireless, and other protocols may be used as well.

The neighborhood data structures, databases, or other data stores described herein can be combined into fewer databases or partitioned or divided into additional databases. In addition, the example processes described herein do not necessarily have to be performed in the described sequence and not all states have to be reached or performed. Various database management systems or data formats may also be used, such as object-oriented database management systems, relational database management systems, flat files, text files, linked lists, arrays, and stacks. Furthermore, flags, Boolean fields, pointers, and other software engineering techniques or algorithmic procedures may be incorporated in the neighborhood-based geocoding or spatial indexing system to implement the features of the present invention. Additionally, embodiments of the present invention may reside in the client side, in the server side, or in both places. Such embodiments, for example, program modules may be created using various tools as known in the art. For example, client side programming or manipulation may include programs written in various programming languages or applications, such as C++, Visual Basic, Basic, C, assembly language, FLASH™ from Macromedia, and machine language. Program modules interfacing with web browsers, such as plug-ins and MICROSOFT™ active X controls, Java™ Scripts, and applets may also be implemented. Server side modules may also be written in programming languages previously mentioned and including other server programming languages, such as Perl, Java, Hypertext Preprocessor (PHP), ColdFusion™ of Macromedia, and the like. Databases shown residing, for example, on the server side may also reside or only reside on the client side. Similarly, databases discussed that may reside on the client side may also reside or only reside in the server side, and client and server refer to client-server architecture.

From the above description, it can be seen that the inventors has developed a database of neighborhood boundaries that incorporates research into spatial cognition and that marries it with an understanding of spatially-enabled database design (e.g., GIS systems). The inventors provide a method that makes an inherently unstructured data set behave like more traditional GIS or geocoded data. The methods described herein define informal spaces like neighborhoods to reflect the practical realities of shared and informal space including that a location might fall in more than one neighborhood depending on the cultural, historical, and other factors that provide bias and subjectivity to users of a geocoded database. Without the structure found in the inventors neighborhood data content the varying or unstructured neighborhoods are troublesome and often ignored in the field of spatial indexing or georeferencing.

In some embodiments, the neighborhoods may be linked to or identified as a particular “type” of neighborhood, and the type of neighborhood may be included as a field in a neighborhood record or in the hood data content created by the methods described herein. One type may be a “Local Search-oriented” neighborhood (i.e., “LS” type). This type of neighborhood is useful for drawing a distinction between neighborhoods located in a commercial or retail district of a city (the LS type) and those that are almost exclusively residential (i.e., RE or real estate type). The LS type is useful for supporting searches on the Internet to retrieve information about restaurants, shopping, and the like and searches performed by search engines of geocoded databases may be limited or directed first to LS type neighborhoods. The RE type of neighborhood, in contrast, typically will include mainly housing subdivisions, homeowner associations, neighborhood associations, and the like, and searches relevant to such neighborhoods would be directed only or first to these areas such as searches performed by a home buyer. Another type of neighborhood is a “Supermunicipal Neighborhood” or SM, which is an informal space that crosses municipal boundaries. These types of neighborhoods or informal spaces may refer to geographic features (e.g., the Rocky Mountains, the Hudson River Valley, or the like) or other informally defined spaces (e.g., the Redneck Riviera, the Rust Belt, and the like). This distinction may be made in some embodiments of the invention to facilitate differing types of searches. For example, it may not be practical to search for coffee shops in New England or some other SN, but it may be very useful to search for a particular type of rental property, a llama farm, or the like in the same informal space. The SN type of informal space or “neighborhood” provides application developers the ability to tailor the data content and a geocoded database formed from such content to suit customer needs and preferences.

1. A computer-based method for creating a data structure for informal geographic: spaces for use in geographically-based searching, comprising:
operating a processor to store in memory a set of data for a geographic region;
identifying a plurality of neighborhoods in the geographic region based on the stored set of data including determining a name for each of the neighborhoods;
generating a boundary definition for each of the neighborhoods by processing neighborhood definition information in the stored set of data;
operating the processor to assign an identifier to each of the neighborhoods;
creating a data structure in the memory for containing neighborhood data content with at least one record for each of the neighborhoods; and
operating the processor to populate the data structure by storing the boundary definition along with the associated one of the names and the associated one of the identifiers in the records of the data structure

2. The method of claim 1, wherein the neighborhood definition information comprises at least two boundary geometries for at least one of the neighborhoods and wherein the generating of the boundary definition for the at least one of the neighborhoods comprises combining the at least two boundary geometries to define a new boundary geometry.

3. The method of claim 2, wherein the new boundary geometry is defined with geographical coordinates defining sides of a polygon and wherein the polygon is configured to include at least area enclosed by the at least two boundary geometries.

4. The method of claim 2, wherein the new boundary geometry includes at least some space found in only one of the at least two boundary geometries.

5. The method of claim 1, wherein the neighborhood definition information comprises a boundary geometry for each of the neighborhoods and wherein the generating of the boundary definition for at least one of the neighborhoods comprises modifying the boundary geometry to define a new boundary geometry for the at least one of the neighborhoods.

6. The method of claim 5, wherein the modifying comprises increasing a size of the boundary geometry of the at least one of the neighborhoods, whereby an area enclosed within the new boundary geometry is greater than an area enclosed within the boundary geometry.

7. The method of claim 1, wherein the boundary definitions of at least two of the neighborhoods are generated such that an overlapping area is enclosed by a boundary geometry of each of the at least two neighborhoods.

8. The method of claim 7, further including operating the processor to designate one of the at least two neighborhoods as dominant and updating the data structure by including data indicating the dominance of the designated one, whereby a geographic coordinate located in both of the as least two neighborhoods can be determined to be in both with one being a primary result.

9. The method of claim 1, further comprising creating a geocoded database by associating each of the neighborhoods with a set of digital content.

10. The method of claim 9, further comprising responding to a search request including a geographic term and a content term by associating the geographic term with one of the neighborhoods and returning a portion of the set of digital content associated with the one of the neighborhoods as a search result.

11. The method of claim 10, wherein the geographic term comprises a neighborhood name corresponding to the name of the one of the neighborhoods or a geographic location corresponding to the boundary definition of the one of the neighborhoods.

12. A method generating informal space definitions for use in spatial indexing, comprising:
operating a computer to access informal space data including geographic coordinates that define boundary geometries for a plurality of informal spaces;
with the computer, identifying a set of the informal spaces that are each associated with at least two of the boundary geometries;
applying an additive algorithm to define a single boundary definition for each of the informal spaces in the identified set, wherein the single boundary definition is inclusive of area enclosed with the at least two associated boundary geometries;
operating the computer to store the single boundary definitions digitally in a data store along with a name and a unique identifier for each of the informal spaces in the identified set; and
with the computer, generating an output including the single boundary definitions, the names, and the unique identifiers.

13. The method of claim 12, further comprising modifying the boundary geometries for a subset of the informal spaces such that a greater area is included within each of the modified boundary geometries.

14. The method of claim 12, wherein the informal spaces comprises neighborhoods and the names comprise neighborhood names.

15. The method of claim 14, further comprising operating the computer to identify pairs of neighborhoods with differing ones of the neighborhood names and substantially similar ones of the boundary geometries and to store an alias relationship for each of the pairs of the neighborhoods in the data store.

16. The method of claim 12, wherein at the single boundary definitions are not exclusive, whereby a geographic location can be within two or more of the single boundary definitions.

17. A memory for storing data for access by an application program being executed on a data processing system, comprising:
a data structure stored in the memory, the data structure including information resident in a database used by said application program and including:
a neighborhood geometry record comprising a plurality of attribute data objects including an identifier for a neighborhood, a name for the neighborhood, and a polygon geometry defining a geographic boundary for the neighborhood; and
a neighborhood relationship record comprising a plurality of attribute data objects including the identifier for the neighborhood and a relationship attribute defining a relationship between the neighborhood associated with the identifier and another neighborhood,
wherein the polygon geometries of at least some of the neighborhoods overlap to include common geographic areas.

18. The memory of claim 17, wherein at least one of the polygonal geometries is configured to include a first area defined by a first boundary definition with a second area defined by a second, differing boundary definition.

19. The memory of claim 17, wherein the relationship determines which of the associated neighborhoods is dominant with regard to one of the common geographic areas.

20. The memory of claim 17, wherein the database is geocoded such that a set of digital content is associated with each of the neighborhoods.
